(19) United States
(12) Patent Application Publication
(10) Pub. No.: US 2001/0048567 A1
(43) Pub. Date: Dec. 6, 2001

(54) Variable spares per track defect management system

(76) Inventors: Yong Peng Chng, Singapore (SG); Steven Tian Chye Cheok, Singapore (SG); Chew Boon Toh, Singapore (SG); Patrick Tai Heng Wong, Singapore (SG)

Correspondence Address: Shawn B Dempster, Seagate Technology LLC, 1280 Disc Drive, Shakopee, MN, 55379-1863, US

(21) Appl. No.: 09/792,583

(22) Filed: Feb. 23, 2001

Related U.S. Application Data
(60) Provisional application No. 60/184,933, filed on Feb. 25, 2000.

(51) Int. Cl. G11B 5/09

(52) U.S. Cl. 360/53; 711/4; 711/201; 714/723

(57) ABSTRACT

A defective track management method is provided for managing defective tracks in a disc drive where the logical zone table is generated after the drive certification test which determines the defect distribution; allocating sectors to achieve a constant number of sectors per track for a particular logical zone in the logical zone table wherein some sectors may be spare sectors allocated efficiently to avoid under sparing or over sparing, as the defect distribution on the disc drive has already been determined; and reassigning defective sectors to the spare sectors corresponding to the track or cylinder where the defective sector is located.

The present invention also can be implemented as a defective track management system on a disk drive.

### CROSS REFERENCE TO RELATED APPLICATIONS

This application claims the benefit of United States Provisional Application No. 60/184,933, filed Feb. 25, 2000.

### FIELD OF THE INVENTION

The present invention relates generally to the field of disc drive storage devices. More particularly, the present invention relates to recording and managing defective track information on a disc surface.

### BACKGROUND OF THE INVENTION

Disc drives are widely used in workstations, personal computers, laptops and other computer systems to store large amounts of data in a form that can be made readily available to a user.

A typical disc drive includes one or more platters (disc media). Either or both surfaces of a platter may be used. The surface of the disc media is divided into a series of data tracks that extend concentrically around the disc. If there is more than one platter in a disc drive, tracks in vertical alignment with one another (having the same track number) define a cylinder.

Each data track is divided into a series of data sectors and data is stored in the form of magnetic transitions on the disc surface. Data sectors are used for writing information to and reading information from disk media. If a data sector is defective, it must be identified to prevent using it. The data is stored and retrieved by a transducer or “head” that is positioned over a desired data track by an actuator arm.

Defect management schemes on a disc drive identify segments of the disc surface that are defective and cannot be used to store data. Such defects can be caused by numerous sources, including thermal asperity, dust particles or other contaminants. These defective locations need to be identified and avoided as no useful information can be recorded in these defective sectors.

Two popular defect management schemes currently in use are the Full Slip Defect System and Fixed Spares Per Track Defect System (Track Based Defect System).

In a Full Slip Defect System, independent of track location on the disk media, a data sector with a factory defect is slipped down the disc to the first available spare data sector and the next available good data sector is assigned as the next Logical Block Address (LBA). A Defect Table which contains a list of sectors which are defective, is stored in the Random Access Memory (RAM) memory of the disc drive electronics system.

When a host wants to access data stored in the disc drive, it provides a LBA or virtual address to the disc drive control electronics system as shown in FIG. 2. The control electronics system then translates the LBA into a physical cylinder-head-sector (PCHS) indicating the physical location of the data within the data tracks of the disc. During each address translation process, the control electronics system has to look up the defect information in the Defect Table for each address being translated. This process contributes to the bulk of the address translation computation overheads.

In the Full Slip Defect System, the sparing region is normally located at the end of the disc as shown in FIG. 3. The first spare sector in this example starts at cylinder 7 head 0. Hence when grown defects are reassigned to this location, degradation of the drive's performance result as sparing cannot be done on the track where the grown defect occurred.

The physical zone layout is the same as the logical zone layout in the full Slip system as no spare sectors are reserved. The conversion process from LBA to PCHS is accomplished by using the logical zone table and the Defect Table. For example, when a user requests for LBA 21 the firmware would search the Defect (Table 1a) and add the accumulated slip to the requested LBA

TABLE 1a
Defect Table

| Index | Next Good LBA | Accumulated Slip |
|---|---|---|
| 0 | 0 | 0 |
| 1 | 20 | 1 |
| 2 | 41 | 2 |
| 3 | 66 | 3 |
| 4 | 71 | 4 |
| 5 | 77 | 5 |
| 6 | 96 | 6 |
| 7 | 110 | 7 |
| 8 | 112 | 8 |
| 9 | 113 | 9 |
| 10 | 143 | 10 |

The adjusted LBA or physical block address (PBA) is then used to compute the target physical address (PCHS) of Cylinder 10/Head 1/Sector 10 with help of the logical zone (table 1b).

TABLE 1b
Logical Zone Table

| Logical | Zone Start | Start | Head 0 | Head 1 |
|---|---|---|---|---|
| Zone | LBA | Cylinder | Secs/Trk | Secs/Trk |
| 0 | 0 | 0 | 12 | 12 |
| 1 | 91 | 4 | 10 | 10 |

TABLE 1c
Physical Zone Table

| Physical | Start | Head 0 | Head 1 |
|---|---|---|---|
| Zone | Cylinder | Secs/Trk | Secs/Trk |
| 0 | 0 | 12 | 12 |
| 1 | 4 | 10 | 10 |

Requested LBA=21

Accumulated Slip=1 (found at index 1)

Adjusted LBA=Requested LBA+Accumulated Slip

Adjusted LBA=21+1

Adjusted LBA=22

PCHS=Cylinder 0/Head 1/Sector 10

In a Fixed Spares Per Track Defect System (FSPT), each track is allocated a fixed amount of spares throughout the whole drive. Defective sectors found during manufacturing process are slipped using the spare sectors assigned to each track. Unused spares can be used to replace grown defects that occurred during the drive's lifetime.

If a track has more defective sectors than the reserved spare sectors, some of the sectors will be reassigned to another track using linear replacement method to achieve the same logical sectors per track. As shown in FIG. 5, LBA 110 is reassigned to Cylinder 6/Head 0/Sector 9 because its local spare sector at Cylinder 5/Head 0/Sector 9 has been used up (by defect at sector 0). This results in ‘Under Sparing’ as the track has more factory defects than spares allocated. Also, this will cause degradation of the drive's performance due to the additional seek latency needed to access the replacement sector.

When the number of spare sectors allocated per track exceed the number of factory defects on the media, a situation called ‘Over Sparing’ would occur. ‘Over Sparing’ results in the reduction of the total usable capacity of the disc as too many unused spares have been reserved.

The main advantage of the Fixed Spares Per Track Defect System is the simplification of the LBA to PCHS translation. The translation is achieved without utilizing the information contained in the Defect Table. This is illustrated in FIG. 4. The LBA translation to PCHS is based on the assumption of a fixed number of logical sectors per track for a given physical recording zone.

FIG. 5 shows the sector layout in a one spare per track FSPT scheme. Tables 2a-c shows the physical zone layout, logical zone layout and the Defect Table respectively.

TABLE 2a
Physical Zone Table

| Physical | Start | Head 0 | Head 1 |
|---|---|---|---|
| Zone | Cylinder | Secs/Trk | Secs/Trk |
| 0 | 0 | 12 | 12 |
| 1 | 4 | 10 | 10 |

TABLE 2b
Logical Zone Table

| Logical | Zone Start | Start | Head 0 | Head 1 |
|---|---|---|---|---|
| Zone | LBA | Cylinder | Secs/Trk | Secs/Trk |
| 0 | 0 | 0 | 11 | 11 |
| 1 | 88 | 4 | 9 | 9 |

TABLE 2c
Track Defect List

| | Defect | | | | Reassigned to |
|---|---|---|---|---|---|
| Index | Head | Cylinder | Sector | Span | Cyl/Head/Sect |
| 0 | 0 | 3 | 2 | 1 | |
| 1 | 0 | 3 | 9 | 1 | 3/1/11 |
| 2 | 0 | 4 | 5 | 1 | |
| 3 | 0 | 5 | 1 | 1 | |
| 4 | 0 | 5 | 3 | 1 | 5/1/9 |
| 5 | 0 | 5 | 5 | 1 | 6/0/9 |
| 6 | 1 | 0 | 8 | 1 | |
| 7 | 1 | 1 | 6 | 1 | |
| 8 | 1 | 2 | 8 | 1 | |
| 9 | 1 | 6 | 6 | 1 | |

The physical zone layout is different from the logical zone layout as one spare sector is reserved through out the whole drive. The conversion process from LBA to PCHS is accomplished by using the logical zone table only as all logical zones are guaranteed a fixed number of sectors per track.

Problems with these two systems are that in a Fixed Spares Per Track Defect System there is always a problem to determine the optimum spares per track for the whole drive. This leads to over sparing or under sparing which can greatly affect the performance of the drive. The Full Slip Defect System requires a large amount of computation overhead for the address translation.

The present invention provides a solution to this and other problems, and offers other advantages over the prior art.

### SUMMARY OF THE INVENTION

The present invention relates to recording and managing defective track information on a disc surface. In accordance with one embodiment of the invention, a defective track management method is provided for managing defective tracks in a disc drive where the logical zone table is generated after the drive certification test which determines the defect distribution; allocating sectors to achieve a constant number of sectors per track for a particular logical zone in the logical zone table wherein some sectors may be spare sectors allocated efficiently to avoid under sparing or over sparing, as the defect distribution on the disc drive has already been determined; and reassigning defective sectors to the spare sectors corresponding to the track or cylinder where the defective sector is located.

The present invention also can be implemented as a defective track management system on a disk drive.

These and various other features as well as advantages which characterize the present invention will be apparent upon reading of the following detailed description and review of the associated drawings.

### BRIEF DESCRIPTION OF THE DRAWINGS

FIG. 1 is a drawing of a disc drive.

FIG. 2 is a block diagram of a Full Slip Defect System.

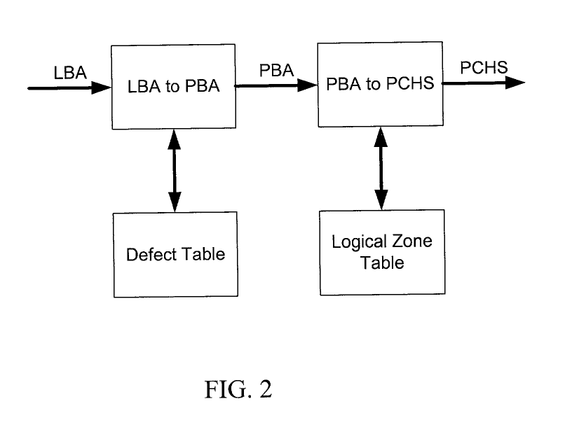

FIG. 3 is a sector layout for a Full Slip Defect System.

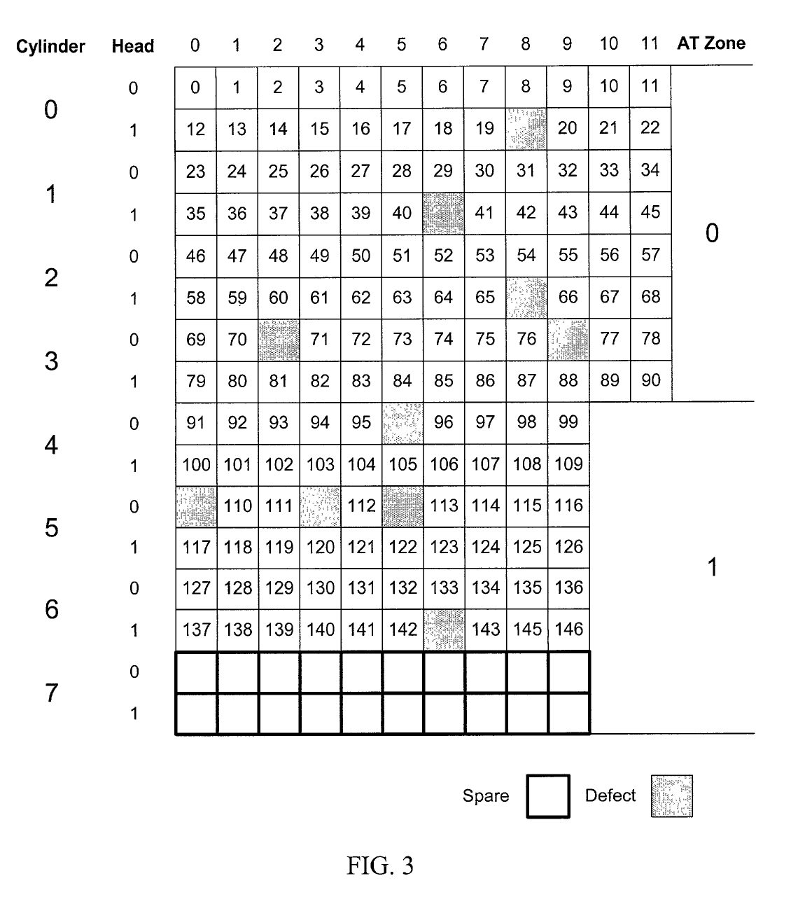

FIG. 4 is a block diagram of a Fixed Spares Per Track Defect System.

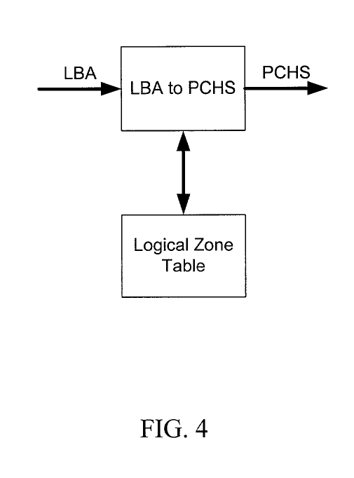

FIG. 5 is a sector layout for a Fixed Spares Per Track Defect System.

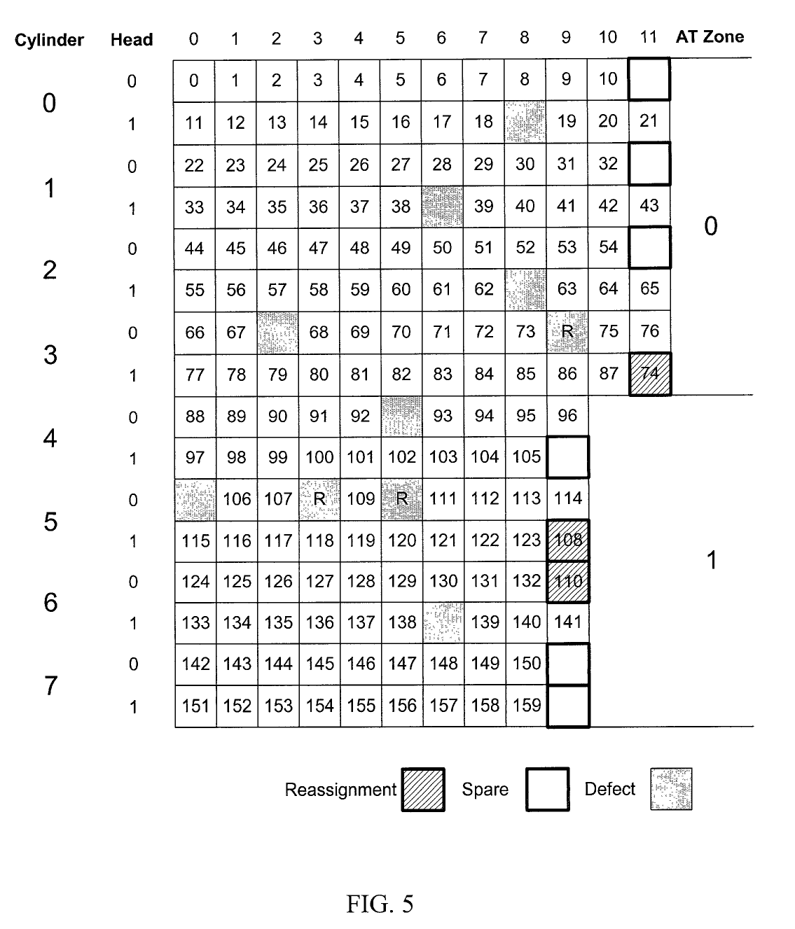

FIG. 6 is a sector layout for one embodiment of the present invention.

FIG. 7 is a block diagram of the preferred embodiment of the present invention.

FIG. 8 is a sector layout for the preferred embodiment of the present invention.

### DETAILED DESCRIPTION

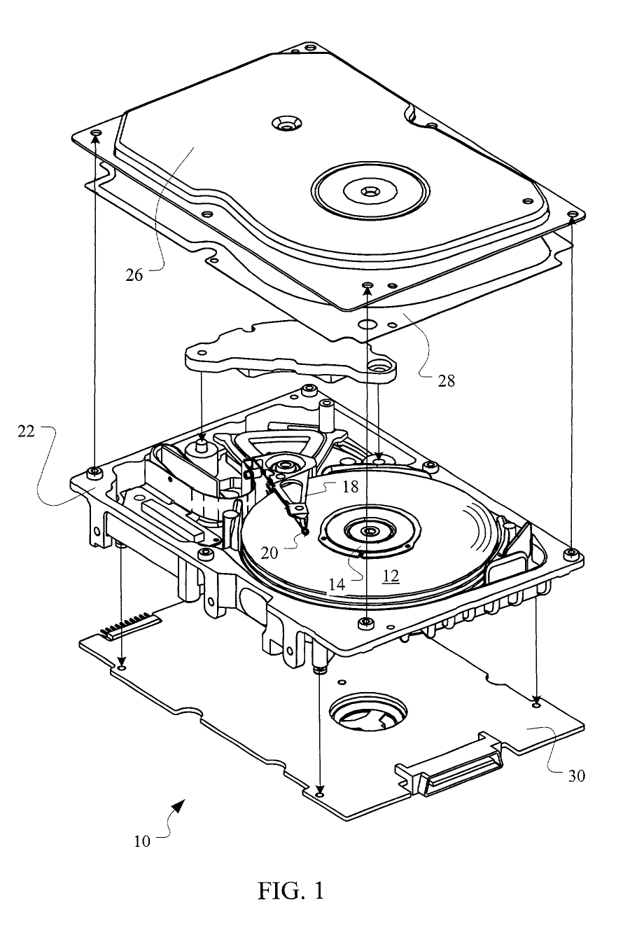

A disc drive 10 as shown in FIG. 1, consists of a cover 26, a gasket 28, a base deck 22, and a printed circuit board assembly (PCBA) 30 mounted to the base deck. The cover 26, gasket 28, and base deck 22 form a head disk assembly (HDA). The basic parts in a HDA include a number of discs 12 mounted on a spindle motor 14 and actuator arms 18, each of which holds out at least one head 20 such that each head reads from or writes to one surface of the discs.

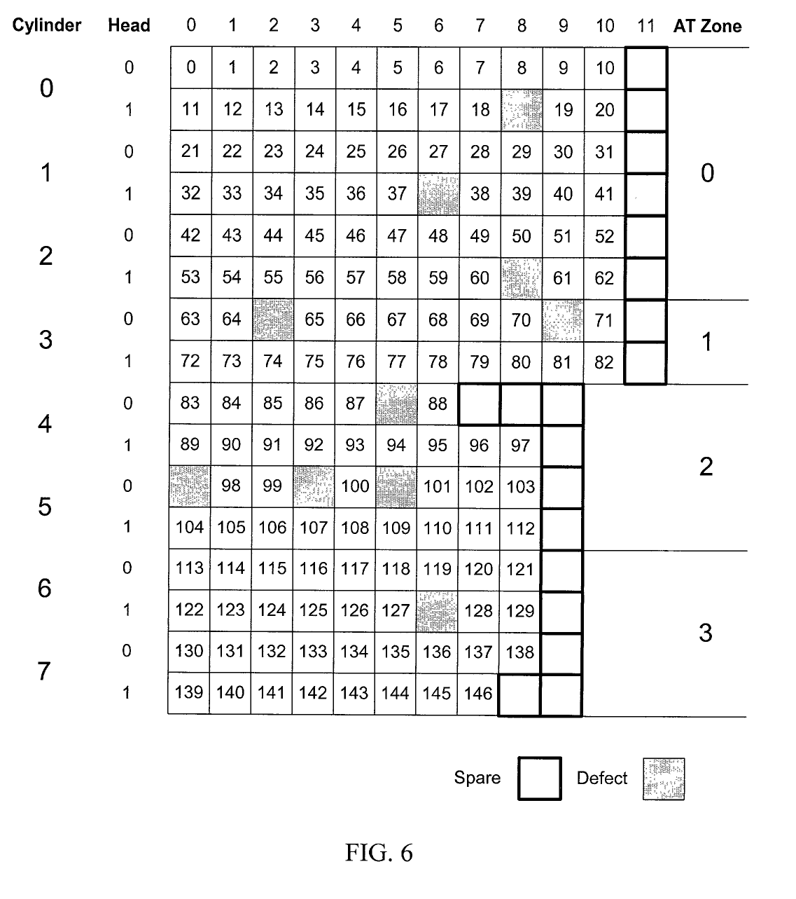

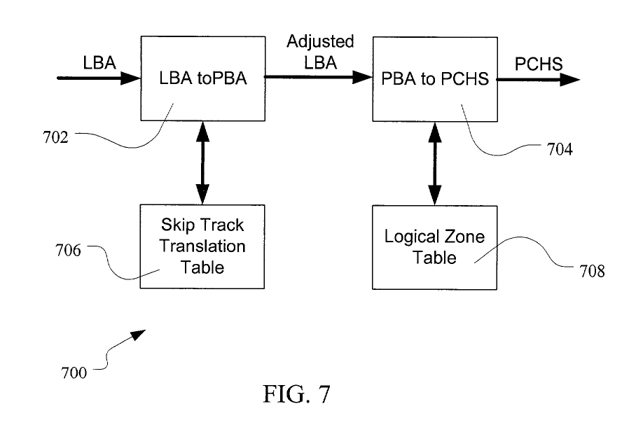

The present invention can be summarized in reference to FIG. 7 which is a block diagram of the preferred embodiment of the disk drive control electronics system 700 for a Variable Spares Per Track Defect Management System. At the core of the Variable Spares Per Track implementation is the Logical Zone Table (LZT) 708 (see example Table 3c). The LZT is generated after the drive certification test. The LZT sub-divides the physical zone into sub-zones which contain tracks affected by similar defect distribution on the disc media. In doing so, a constant number of sectors per track is achieved for a particular logical zone. As the LZT is generated after drive certification, spare sectors can be allocated efficiently as the defect distribution on the drive has already been determined. FIG. 6 shows a sector layout with a variable spares per track scheme. There is at least one local spare sector reserved on each track for reallocating grown media defects. Thus, access latency to the reassigned sector is reduced significantly.

The disk drive control electronics system 700 includes a logical block address (LBA) to physical block address (PBA) translation process 702. During the LBA to PBA translation process, the firmware will search the Skip Track Translation Table (STTT) 706 and add any accumulated slip to the requested LBA to obtain an adjusted LBA or a PBA. The adjusted LBA or PBA is then used in an adjusted LBA to PCHS translation process 704 to obtain the target physical address (PCHS) with the help of the logical zone table 708. To obtain the PCHS, the firmware will take the adjusted LBA and determine which logical zone the adjusted LBA resides in. The adjusted LBA is then subtracted from the Zone Start LBA which is obtained from the Logical Zone Table to give the zone offset LBA. Next, the zone offset LBA is divided by the number of sectors per cylinder to determine the cylinder offset into the logical zone. Lastly, track adjustment is done to get the exact head and sector location.

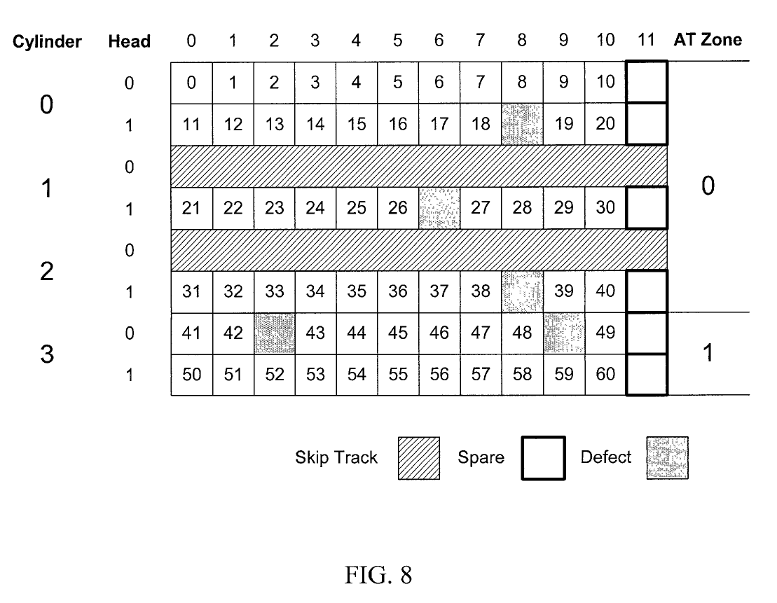

Example Tables 3a-d show the skip track translation table, physical zone layout, logical zone layout and the defect table respectively. The data in Tables 3a-d correspond to FIG. 6 and FIG. 8.

TABLE 3a
Skip Track Translation Table (STTT)

| LBA | Accumulated Slip |
|---|---|
| 0 | 0 |
| 21 | 11 |
| 31 | 22 |

TABLE 3b
Physical Zone Table

| Physical | Start | Head 0 | Head 1 |
|---|---|---|---|
| Zone | Cylinder | Secs/Trk | Secs/Trk |
| 0 | 0 | 12 | 12 |
| 1 | 4 | 10 | 10 |

TABLE 3c
Logical Zone Table

| Logical | Zone Start | Start | Head 0 | Head 1 |
|---|---|---|---|---|
| Zone | LBA | Cylinder | Secs/Trk | Secs/Trk |
| 0 | 0 | 0 | 11 | 10 |
| 1 | 63 | 3 | 9 | 11 |
| 2 | 83 | 4 | 6 | 9 |
| 3 | 113 | 6 | 9 | 8 |

TABLE 3d
Track Defect List

| | Defect | | | |
|---|---|---|---|---|
| Index | Head | Cylinder | Sector | Span |
| 0 | 0 | 3 | 2 | 1 |
| 1 | 0 | 3 | 9 | 1 |
| 2 | 0 | 4 | 5 | 1 |
| 3 | 0 | 5 | 1 | 1 |
| 4 | 0 | 5 | 3 | 1 |
| 5 | 0 | 5 | 5 | 1 |
| 6 | 1 | 0 | 8 | 1 |
| 7 | 1 | 1 | 6 | 1 |
| 8 | 1 | 2 | 8 | 1 |
| 9 | 1 | 6 | 6 | 1 |

For example, if the requested LBA is 34, then using the STTT (Table 3a) the accumulated slip is 22. The adjusted LBA or PBA is then equal to 34+22=56. Using the adjusted LBA of 56, the PCHS of Cylinder 2/Head 1/Sector 3 is computed using the logical zone table. In other terms:

requested LBA=34

Accumulated Slip=22

adjusted LBA=34+22=56

zone start LBA=0

zone offset LBA=56−0=56

start cylinder=0

cylinder offset=56/21=Cylinder 2 remainder 14

track adjustment=14−11=Head 1 remainder 3

PCHS=Cylinder 2/Head 1/Sector 3

Another example (using Table 3a and Table 3c):

requested LBA=60

Accumulated Slip=>

adjusted LBA=60+22=82

zone start LBA=63

zone offset LBA=82−63=19

start cylinder=3

cylinder offset=19/20=Cylinder 0 remainder 19

track adjustment=19−9=Head 1 remainder 10

PCHS=Cylinder 3/Head 1/Sector 10

One of the advantages of the disk drive control electronics system 700 for a Variable Spares Per Track Defect Management System over other types of designs is that address translation only requires logical zone information and is independent of defect distribution on the disc media. Also, since a Variable Spares Per Track Defect Management System is track based, defect information need not be stored in off-disk memory such as system RAM. This frees up a large amount of memory space.

As compared to the Fixed Spares Per Track Defect System, the present invention does not have the problems of over sparing or under sparing. Furthermore, there is an increased probability of reassigning grown defects onto the same track as spares are allocated only after disk certification. This leads to improved access time to reassigned sectors as spares are guaranteed on the same track or cylinder. Improved access time is critical when the disk drive is operated under demanding audio or video streaming applications. On-the-fly reassignment to slip defect conversion is made possible as reassignment of grown defects is done on the same track.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the Variable Spares Per Track Defect Management System while maintaining substantially the same functionality without departing from the scope and spirit of the present invention.

What is claimed is:

1. A method for managing defective tracks in a disc drive having tracks subdivided into a plurality of sectors, wherein the tracks are prearranged into a physical zone, comprising steps of:
(a) generating a Logical Zone Table that sub-divides the physical zone into sub-zones, where the Logical Zone Table is generated after the drive certification test which determines the defect distribution and where the sub-zones are based on tracks affected by similar defect distribution;
(b) allocating sectors to achieve a constant number of sectors per track for a particular logical zone in the Logical Zone Table wherein some sectors may be spare sectors allocated efficiently to have at least one local spare sector reserved on each track for reallocating grown media defects; and
(c) reassigning defective sectors to the spare sectors corresponding to the track or cylinder where the defective sector is located.

2. The method of claim 1, further comprising a step of:
(d) skipping tracks that have been determined to be unusable.

3. The method of claim 2, wherein tracks with bad servo wedges are skipped.

4. The method of claim 2, wherein tracks with multiple bad sectors are skipped.

5. A disc drive, comprising:
(a) a head controllably positionable adjacent a rotatable disc;
(b) a read/write channel which controls transfer of data between the disc and a host computer in which the disc is mountable;
(c) a servo circuit which controls position of the head;
(d) media surfaces, each having a physical zone with a plurality of data tracks, and at least one data track comprises a plurality of data sectors wherein one or more of the data sectors are spare data sectors which are positioned efficiently to have at least one local spare sector reserved on each track for reallocating grown media defects;
(e) a spare track defect management system with a logical zone table where the physical zone is divided into sub-zones due to the defect distribution of the disc drive as determined after drive certification, the spare data sectors being assigned to provide a constant number of sectors per track for a particular logical zone.

6. The disc drive of claim 5, further comprising element (f), a Skip Track Translation Table which provides the accumulated slip for the corresponding requested logical block address.

7. The disc drive of claim 6, where the accumulated slip is due to unusable tracks.

8. The disk drive of claim 7, wherein tracks with bad servo wedges are unusable.

9. The disk drive of claim 7, wherein tracks with multiple bad sectors are skipped.

10. A disc drive, comprising:
(a) media surfaces which contain defective segments; and
(b) means for managing the defective segments of the media surface by means of efficiently allocating the placement of spare sectors on the media surface.
